(19) United States
(12) Patent Application Publication
(10) Pub. No.: US 2009/0284049 A1
(43) Pub. Date: Nov. 19, 2009

(54) Sunroof Mounting Assembly

(75) Inventor: Jae Kyung LEE, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/324,372

(22) Filed: Nov. 26, 2008

(30) Foreign Application Priority Data
May 13, 2008 (KR) 10-2008-0043962

(51) Int. Cl. B60J 7/043

(52) U.S. Cl. 296/216.04

(57) ABSTRACT

A sunroof mounting assembly may be configured so that a ring reinforcement is secured along an edge of a sunroof hole and a sunroof rail for guiding movement of a sunroof is mounted to the ring reinforcement. The ring reinforcement may include: a first reinforcement mounted to front and side edges of the sunroof hole to selectively receive the sunroof therein; and a second reinforcement provided on a rear edge of the sunroof hole, wherein the second reinforcement couples each distal end of the first reinforcement.

### CROSS-REFERENCE TO RELATED APPLICATIONS

The present application claims priority to Korean Patent Application Number 10-2008-0043962, filed on May 13, 2008, the entire contents of which application is incorporated herein for all purposes by this reference.

### BACKGROUND OF THE INVENTION

1. Field of the Invention

The present invention relates to a sunroof mounting assembly, in which a ring reinforcement is mounted around the sunroof hole of a roof panel.

2. Description of Related Art

A sunroof is selectively mounted to a roof of a vehicle to open a glass panel and a sunshade.

As shown in FIGS. 1 to 3, a sunroof hole 11 is formed in a roof panel 10 of a vehicle and is opened or closed by a sunroof 20. A ‘□’-shaped ring reinforcement 30 is fixedly welded to the edge of the sunroof hole 11, and sunroof rails 40 are mounted to the ring reinforcement 30 so that the sunroof 20 slidably moves along the sunroof rails 40.

Particularly, the front and side portions 32 of the ring reinforcement of the sunroof hole 11 are fixedly welded to the edge of the sunroof hole 11, and the rear portion 31 of the ring reinforcement is secured to the edge of the sunroof hole 11 via a sealer. Since it is difficult to weld the rear portion 31 of the ring reinforcement to the edge of the sunroof hole 11, drone noise may be generated due to the flow of external air in the rear portion 31 of the ring reinforcement when the vehicle is driven with the sunroof 20 open.

As shown in FIGS. 4a and 4b, the rear portion 31 of the ring reinforcement is secured to the rear portion of the sunroof hole 11 via the sealer, so that the coupling force of the rear portion 31 of the ring reinforcement with the rear portion of the sunroof hole 11 is weak. Thus, the rear portion 31 of the ring reinforcement sags downwards due to its weight, and this in turn results in the rear portion 31 of the ring reinforcement not reliably supporting the roof panel 10, so that the roof panel 10 may be shaken up and down and interfere with the sunroof 20.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide for a sunroof mounting assembly which prevents the rear end of a ring reinforcement from sagging.

In an aspect of the present invention, a sunroof mounting assembly may be configured so that a ring reinforcement is secured along an edge of a sunroof hole and a sunroof rail for guiding movement of a sunroof is mounted to the ring reinforcement. The ring reinforcement may include a first reinforcement mounted to front and side edges of the sunroof hole to selectively receive the sunroof therein, and/or a second reinforcement provided on a rear edge of the sunroof hole, wherein the second reinforcement couples each distal end of the first reinforcement.

The sunroof rail may be coupled to side inner panel.

The sunroof rail may include a mounting bracket and is coupled to the side inner panel by the mounting bracket.

Upper edge of the first reinforcement may be secured to inner surface of the roof panel.

The first reinforcement may include at least a reinforcement member which are coupled to each other through welding.

Distal end portion of the second reinforcement may be spaced from the sunroof rail with a predetermined distance in a longitudinal direction of the sunroof.

The second reinforcement may be spaced from the sunroof rail with a predetermined distance in a vertical direction to slidably receive the sunroof therebetween.

The second reinforcement may include an additional reinforcing frame to increase rigidity.

The additional reinforcing frame may be configured to be dented at one surface along the longitudinal direction thereof.

The second reinforcement may include a bent portion which is secured to the sunroof rail.

The first reinforcement may include a bent portion which is secured to both the sunroof rail and the bent portion of the second reinforcement.

A nut may be welded to the bent portion of the first reinforcement and the first reinforcement, the sunroof rail, and the bent portion of the second reinforcement are bolted together through the nut.

The bent portion of the first reinforcement, the sunroof rail, and the bent portion of the second reinforcement may be secured to a reinforcing panel disposed under the sunroof rail.

A nut may be welded to the bent portion of the first reinforcement and the first reinforcement, the sunroof rail, and the bent portion of the second reinforcement are bolted together to the reinforcing panel through the nut.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating the state in which a ring reinforcement is mounted to a roof panel in a conventional sunroof mounting assembly.

FIG. 2 is a view illustrating the state in which a sunroof and sunroof rails are mounted to the roof panel equipped with the ring reinforcement of FIG. 1.

FIG. 3 is a partial sectional view taken along line “A-A” of FIG. 1.

FIG. 4a is a view illustrating the normal operating state of the conventional sunroof mounting assembly.

FIG. 4b is a view illustrating the abnormal operating state of the conventional sunroof mounting assembly.

FIG. 5 is a view illustrating an exemplary sunroof mounting assembly according to the present invention.

FIG. 6 is a partial sectional view taken along line “B-B” of FIG. 5.

FIG. 7 is a view illustrating the construction of an exemplary first reinforcement which is separated from a ring reinforcement according to the present invention.

FIG. 8 is a view illustrating the state in which reinforcement members of the first reinforcement of FIG. 7 are coupled to each other.

FIG. 9 is a view illustrating the state in which the first reinforcement of FIG. 8 is mounted to a roof panel and a sunroof and sunroof rails are mounted to the roof panel.

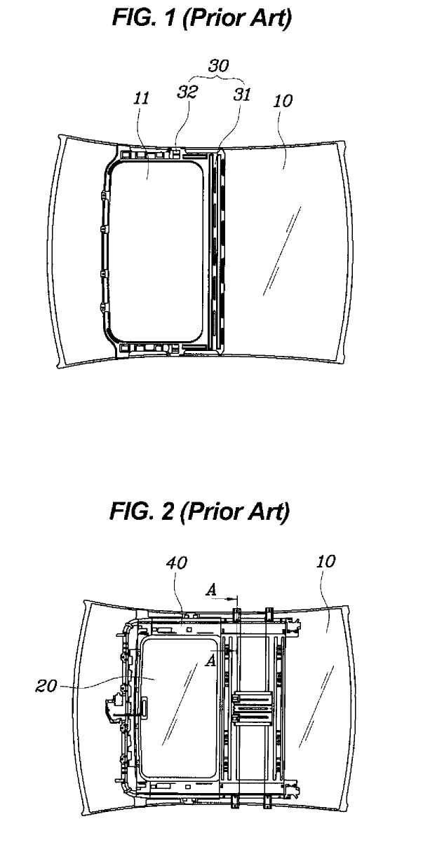

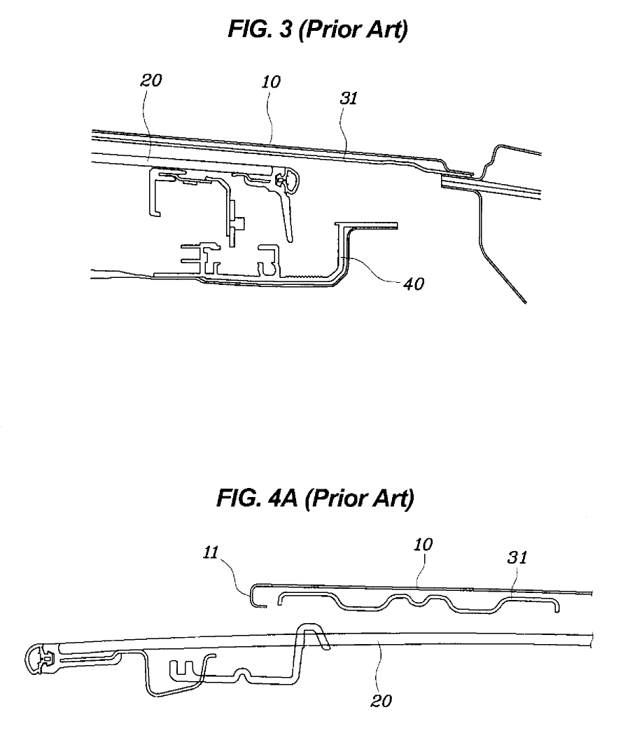

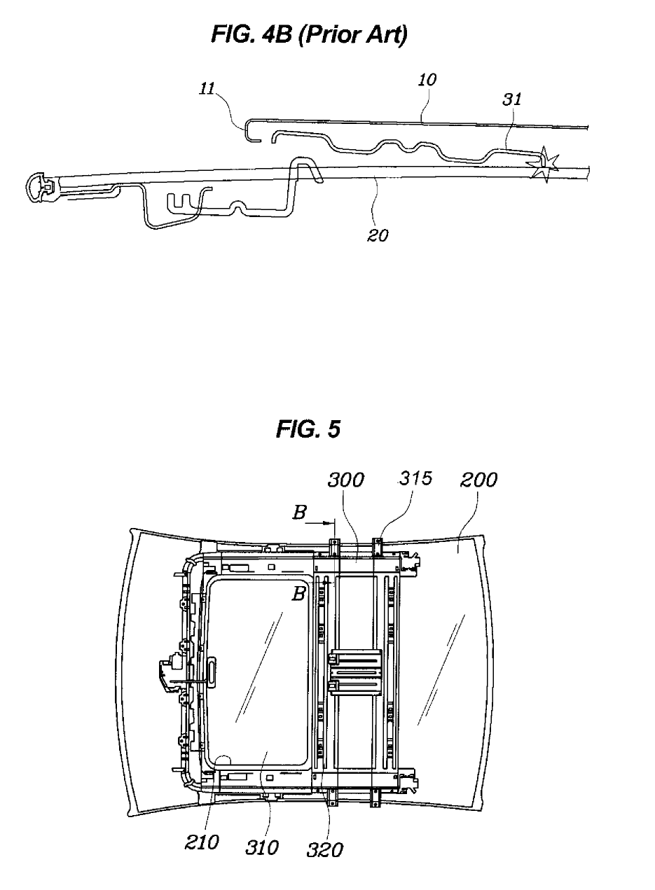

### DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is,are intended to cover not only the exemplary embodiments, but also various alternatives, modifications, equivalents and other embodiments, which may be included within the spirit and scope of the invention as defined by the appended claims.

Various embodiments of the present invention will be described in detail with reference to the accompanying drawings.

A sunroof mounting assembly, in various embodiments of the present invention, is characterized in that a portion of a reinforcement provided on the rear portion of a sunroof hole in a roof panel is bent and secured to sunroof rails, thus preventing interference between the rear portion of the reinforcement and the sunroof occurring due to sagging of the rear portion of the reinforcement.

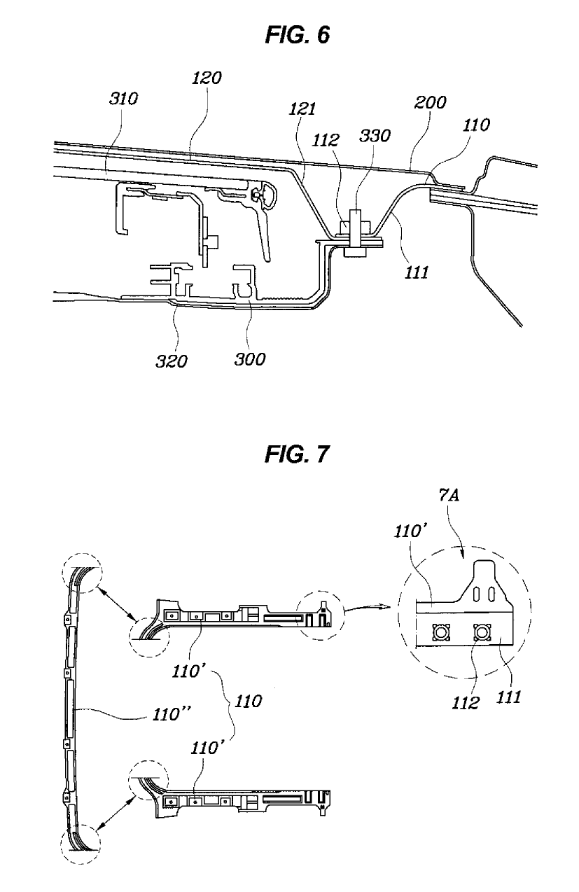

The construction for accomplishing the above-mentioned characteristics will be described in detail. As shown in FIGS. 5 and 6, a sunroof hole 210 is formed in a roof panel 200 to open or close a sunroof 3 10. A ring reinforcement 100 is mounted to the edge of the sunroof hole 210 to mount a sunroof mil 300.

The sunroof rail 300 comprises a pair of sunroof rails which are provided on the opposite sides of the sunroof hole 210 in such a way as to be spaced apart from each other and are arranged in the longitudinal direction of a vehicle body, so that the sunroof rails are welded or bolted to the ring reinforcement 100. The sunroof rails 300 are connected to each other via reinforcing panels 320 which are transversely provided between the sunroof rails 300. Further, the sunroof rails 300 are secured to side inner panels via mounting brackets 315.

The ring reinforcement 100 is fixedly welded to the edge of the sunroof hole 210, and includes a first reinforcement 110 and a second reinforcement 120.

The first reinforcement 110 has a ‘U’ shape and is mounted to the front and side edges of the sunroof hole 210. Further, after a plurality of reinforcement members are separately manufactured, the reinforcement members are welded to each other, thus providing the ‘U’-shaped first reinforcement 110.

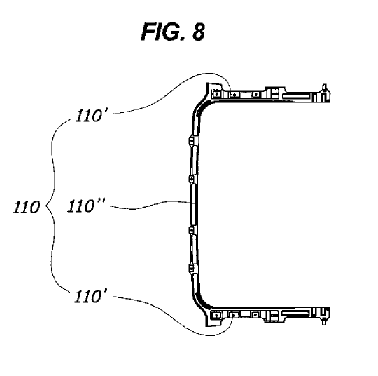

For example, as shown in FIG. 7, the first reinforcement 110 may include a front reinforcement member 110″ which is mounted to the front edge of the sunroof hole 210, and side reinforcement members 110′ which are mounted to the side edges of the sunroof hole 210 and are manufactured separately from the front reinforcement member 110″. As shown in FIG. 8, the front reinforcement member 110″ and the side reinforcement members 110′ which are manufactured in this way are welded to each other, thus providing one first reinforcement 110. The first reinforcement 110 is assembled with the roof panel 200 on a body assembly line through bolting or welding.

As described above, in the case of the conventional sunroof mounting assembly, the ring reinforcement is manufactured using a single member. However, in the case of the sunroof mounting assembly according to various embodiments of the present invention after one front reinforcement member 110″, two side reinforcement members 110′, and one second reinforcement 120 are manufactured, they are assembled into one ring reinforcement 100. Thus, the present invention is advantageous in that it is convenient to store and carry the material of the ring reinforcement and material yield is improved.

According to various embodiments, the front reinforcement member 110″ and the side reinforcement members 110′ are separately manufactured and thereafter assembled into the first reinforcement 110. However, the first reinforcement 110 may be manufactured using one first reinforcement 110 having the ‘U’ shape.

The second reinforcement 120 is provided on the rear edge of the sunroof hole 210 to reinforce the rear edge of the sunroof hole 210. Further, both ends of the second reinforcement 120 are bent downwards, thus forming second bent portions 121 which are secured to the side parts of the sunroof rails 300. Here, the second bent portions 121 may be secured to the side parts of the sunroof rails 300 by bolting or welding.

As such, both ends of the second reinforcement 120 are bent downwards and are secured to the sunroof rails 300, thus preventing the second reinforcement 120 from sagging downwards, and keeping a gap between the second reinforcement 120 and the roof panel 200 constant, therefore ensuring rigidity.

The second reinforcement 120 may include an additional reinforcing fame 125 to increase rigidity. In various embodiments of the present invention, the additional reinforcing frame 125 may be formed to be dented at the second reinforcement 120 along the longitudinal direction thereof.

As shown in FIG. 7, partial FIG. 7A shows that each side reinforcement member 110′ of the first reinforcement 110 may have a first bent portion 111 which is secured to the corresponding sunroof rail 300. A nut 112 is welded to the first bent portion 111. Thus, the second reinforcement 120 may be coupled to each sunroof rail 300 and second bent portion 121 by inserting a bolt 330 into the nut 112 of the first bent portion 111.

Further, in the case where the second reinforcement 120 is thin, so that the rigidity of the second reinforcement 120 is weak the thick second reinforcement 120 is manufactured and is applied to various embodiments, thus increasing its rigidity.

The assembling process of the present invention constructed as described above will be described below in brief.

First, as shown in FIG. 7, the front and side reinforcement members are separately manufactured. As shown in FIG. 8, the front and side reinforcement members are assembled into one first reinforcement 110 through welding.

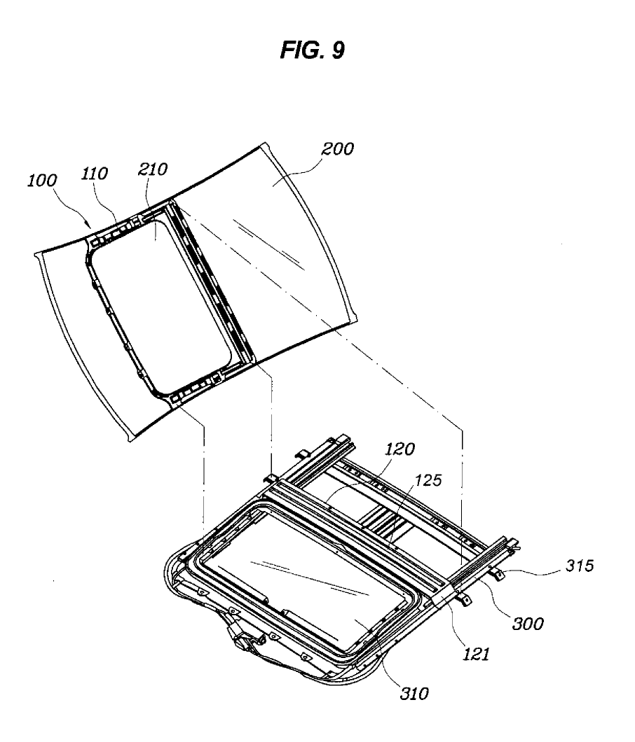

As shown in FIG. 9, the first reinforcement 110 is coupled to an assembly consisting of the sunroof 310, the sunroof rails 300, and the second reinforcement 120. Here, the first bent portions 111 of the first reinforcement 110 are fastened via bolts 330 to the sunroof rails 300 to which the second bent portions 121 of the second reinforcement 120 are secured. The second reinforcement 120 is secured to the side inner panels via the mounting brackets 315.

As described above, a sunroof mounting assembly according to various aspects of the present invention is advantageous in that a portion of a reinforcement provided on the rear portion of a sunroof hole is secured to sunroof rails, thus preventing interference between the rear portion of the reinforcement and a sunroof due to the sagging of the rear portion of the reinforcement. Further, the sunroof mounting assembly according to the present invention is advantageous in that a coupling end of the rear portion of the reinforcement is bent downwards to be secured to the sunroof, thus ensuring rigidity.

Furthermore, a sunroof mounting assembly according to the present invention is advantageous in that a ring reinforcement comprises four pieces, thus improving material yield and formability.

For convenience in explanation and accurate definition in the appended claims, the terms “front” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sunroof mounting assembly including a ring reinforcement secured along an edge of a sunroof hole and a sunroof rail for guiding movement of a sunroof mounted to the ring reinforcement, wherein the ring reinforcement comprises:
a first reinforcement mounted to front and side edges of the sunroof hole to selectively receive the sunroof therein; and
a second reinforcement provided on a rear edge of the sunroof hole, wherein the second reinforcement couples each distal end of the first reinforcement.

2. The sunroof mounting assembly as set forth in claim 1, wherein the sunroof rail is coupled to a side inner panel.

3. The sunroof mounting assembly as set forth in claim 2, wherein the sunroof rail includes a mounting bracket and is coupled to the side inner panel by the mounting bracket.

4. The sunroof mounting assembly as set forth in claim 1, wherein an upper edge of the first reinforcement is secured to an inner surface of the roof panel.

5. The sunroof mounting assembly as set forth in claim 1, wherein the first reinforcement comprises at least a reinforcement member welded thereto.

6. The sunroof mounting assembly as set forth in claim 1, wherein a distal end portion of the second reinforcement is spaced from the sunroof rail at a predetermined distance in a longitudinal direction of the sunroof.

7. The sunroof mounting assembly as set forth in claim 1, wherein the second reinforcement is spaced from the sunroof rail at a predetermined distance in a vertical direction to slidably receive the sunroof therebetween.

8. The sunroof mounting assembly as set forth in claim 1, wherein the second reinforcement includes an additional reinforcing frame to increase rigidity.

9. The sunroof mounting assembly as set forth in claim 8, wherein the additional reinforcing frame is ribbed on one surface along a longitudinal direction thereof.

10. The sunroof mounting assembly as set forth in claim 1, wherein the second reinforcement comprises a bent portion which is secured to the sunroof rail.

11. The sunroof mounting assembly as set forth in claim 10, wherein the first reinforcement comprises a bent portion which is secured to both the sunroof rail and the bent portion of the second reinforcement.

12. The sunroof mounting assembly as set forth in claim 11, wherein a nut is welded to the bent portion of the first reinforcement and wherein the nut is used to secure together the first reinforcement, the sunroof rail, and the bent portion of the second reinforcement.

13. The sunroof mounting assembly as set forth in claim 11, wherein the bent portion of the first reinforcement, the sunroof rail, and the bent portion of the second reinforcement are secured to a reinforcing panel disposed under the sunroof rail.

14. The sunroof mounting assembly as set forth in claim 13, wherein a nut is welded to the bent portion of the first reinforcement, and wherein the nut is used to secure together the first reinforcement the sunroof rail, and the bent portion of the second reinforcement to the reinforcing panel.

15. A passenger vehicle comprising the sunroof mounting assembly as set forth in claim 1.
